(19) United States
(12) Patent Application Publication
(10) Pub. No.: US 2017/0153495 A1
(43) Pub. Date: Jun. 1, 2017

(54) ANTI-BLUE LIGHT POLARIZERS AND LIQUID CRYSTAL DISPLAY PANELS

(71) Applicant: Shenzhen China Star Optoelectronics Technology Co. Ltd., Shenzhen, Guangdong (CN)

(72) Inventor: Hongquan Wei, Shenzhen City (CN)

(21) Appl. No.: 14/786,157

(22) PCT Filed: Aug. 24, 2015
(86) PCT No.: PCT/CN2015/087965

§ 371 Date: Oct. 21, 2015

(30) Foreign Application Priority Data
Aug. 14, 2015 (CN) 201510502634.1

(51) Int. Cl. G02F 1/1335; G02B 5/30

(52) U.S. Cl. CPC G02F 1/133533; G02F 1/133514; G02B 5/3016; G02F 2203/055; G02F 2202/022

(57) ABSTRACT

The present application provides an anti-blue light polarizer and a liquid crystal display panel. The anti-blue light polarizer includes at least a left spiral cholesteric phase liquid crystal film and at least a right spiral cholesteric phase liquid crystal film, the left spiral cholesteric phase liquid crystal film and the right spiral cholesteric phase liquid crystal film mutually stack, and pitches of the left spiral cholesteric phase liquid crystal and pitches of the right spiral cholesteric phase liquid crystal are within wavelength range of the blue light, so that the left spiral cholesteric phase liquid crystal film reflects left spiral light in the blue light, the right spiral cholesteric phase liquid crystal film reflects right spiral light in the blue light, then all the blue light are reflected and cannot enter human eyes, and thus a favorable anti-blue light effect is achieved.

### FIELD OF THE INVENTION

The present application relates to a technical field of liquid crystal, especially to an anti-blue light polarizer and a liquid crystal display panel.

### BACKGROUND OF THE INVENTION

With swift and violent development of electronic technology and display technique, liquid crystal displays (LCD) obtain extensive applications, such as liquid crystal TV, smart phone, computer screen and the like.

Most of the liquid crystal display devices in the present market are backlight type liquid crystal display devices which include liquid crystal display panels and backlight module.

The liquid crystal display panel is usually consisting of a color filter (CF) substrate, a thin film transistor (TFT) array substrate and a liquid crystal layer disposed between the two layers. A side of the CF substrate away from the liquid crystal layer is adhered with a polarizer, a side of the TFT substrate away from the liquid crystal layer is adhered with a polarizer. The liquid crystal display panel performs orientation of the liquid crystal molecules through electric field to change polarization state of light, and the panel implements penetration and barrier of light path by the polarizers, so as to achieve the object of display.

The backlight module usually uses light emitting diode (LED) as a backlight source. Light emitting from LED include blue light which have very large impact on human health. The blue light refer to a high energy light of wavelength in 380˜480 nm, the blue light having short wavelength and high energy can directly irradiate retina, and long-term accumulation of the blue light cause eye fatigue, dryness, decreased visual acuity, and easy to stimulate brown pigments that allow macula and freckles grow on skin at the same time. Therefore, a way of anti-blue light becomes one problem in the display industry urgently needed to be solved. The current main solutions are that an anti-blue light protection film is adhered to the screen, or the user wears on anti-blue light glasses; however, the two solutions will derive other problems, such as reduced screen brightness, inconvenience use, color difference and other issues.

Cholesteric phase liquid crystal is a special form of nematic liquid crystals. As shown in FIG. 1, molecules of the cholesteric phase liquid crystal 201 are arranged in multilayers, long axis of molecules 201 in each plane layer are parallel, but orientations of the long axis of molecules 201 in different plane layers gradually deflect, a director of each plane layer twists by layers, normal directions of the cholesteric phase liquid crystal molecules 201 along the plane layer show periodic spiral arrangement. A distance between the normal directions corresponding to the long axis orientation of molecules 201 through 360° change is called as pitch P. Deflection twist of the cholesteric phase liquid crystal can be left spiral, also right spiral that depends on the difference of the structure of molecule 201.

Due to the special spiral structure of the cholesteric phase liquid crystal which has Bragg reflection characteristic. That is, when a wavelength of incident light satisfies λ=nP, the incident light will be reflected, wherein λ is the wavelength of the incident light, P is the pitch of the cholesteric phase liquid crystal, n is an average refractive index, n is relatively fixed, and the wavelength of the incident light can thus be control by adjusting P.

At the same time, as shown in FIG. 2, the cholesteric phase liquid crystal 200 further has apparent circular dichroism, when a bundle of light passes through the cholesteric phase liquid crystal 200, only the circular polarized light which follows Bragg reflection formula and the spiral direction of the cholesteric phase liquid crystal 200 is reflected, and the rest of the light is transmitted; in other words, the cholesteric phase liquid crystal 200 can reflect the light which has an optical rotation identical thereto, so that a reflective index of the cholesteric phase liquid crystal 200 is 50%. By utilizing such a characteristic of the cholesteric phase liquid crystal selectively reflecting light, the blue light can effectively be reflected, so that the blue light cannot enter human eyes.

### SUMMARY OF THE INVENTION

An object of the present application is to provide an anti-blue light polarizer, which utilizes the characteristic of the cholesteric phase liquid crystal selectively reflecting light to effectively reflect the blue light, so that the blue cannot enter human eyes, and a favorable anti-blue light effect is achieved.

Another object of the present application is to provide a liquid crystal display panel, which is capable of achieving the favorable anti-blue light effect with the premise of not reducing screen brightness and not producing color difference.

For the above objects, the present application firstly provides an anti-blue light polarizer including at least a left spiral cholesteric phase liquid crystal film and at least a right spiral cholesteric phase liquid crystal. The left spiral cholesteric phase liquid crystal film and the right spiral cholesteric phase liquid crystal mutually stack, and pitches of the left spiral cholesteric phase liquid crystal in the left spiral cholesteric phase liquid crystal film and pitches of the right spiral cholesteric phase liquid crystal in the right spiral cholesteric phase liquid crystal film are within the wavelength range of the blue light.

The pitches of the left spiral cholesteric phase liquid crystal and the pitches of the right spiral cholesteric phase liquid crystal are in 380˜480 nm.

Optionally, the right spiral cholesteric phase liquid crystal film stacks on the left spiral cholesteric phase liquid crystal film.

Optionally, the left spiral cholesteric phase liquid crystal film stacks on the right spiral cholesteric phase liquid crystal film.

The anti-blue light polarizer further includes a polarizing layer, an upper protection layer and a lower protection layer respectively disposed on upper and lower surfaces of the polarizing layer, a pressure sensitive adhesive layer disposed on a lower surface of the lower protection layer, a release film disposed on a lower surface of the pressure sensitive adhesive layer, and a surface protection film.

The mutually stacked left spiral cholesteric phase liquid crystal film and right spiral cholesteric phase liquid crystal film are disposed between the surface protection film and the upper protection layer.

A material of the polarizing layer is polyvinyl alcohol; materials of the upper protection layer and the lower protection layer are triacetate cellulose.

The present application further provides a liquid crystal display panel including a color film substrate and an array substrate oppositely disposed, a liquid crystal layer disposed between the two substrates, an upper polarizer adhered to a side of the color film substrate away from the liquid crystal layer, and a lower polarizer adhered to a side of the array substrate away from the liquid crystal layer.

The upper polarizer is an anti-blue light polarizer including at least a left spiral cholesteric phase liquid crystal film and at least a right spiral cholesteric phase liquid crystal film film, the left spiral cholesteric phase liquid crystal film and the right spiral cholesteric phase liquid crystal film mutually stack, and pitches of the left spiral cholesteric phase liquid crystal in the left spiral cholesteric phase liquid crystal film and pitches of the right spiral cholesteric phase liquid crystal in the right spiral cholesteric phase liquid crystal film are within the wavelength range of the blue light.

The pitches of the left spiral cholesteric phase liquid crystal and the pitches of the right spiral cholesteric phase liquid crystal are in 380˜480 nm.

The right spiral cholesteric phase liquid crystal film stacks on the left spiral cholesteric phase liquid crystal film, or the right spiral cholesteric phase liquid crystal film stacks on the left spiral cholesteric phase liquid crystal film.

The anti-blue light polarizer further includes a polarizing layer, an upper protection layer and a lower protection layer respectively disposed upper and lower surfaces of the polarizing layer, a pressure sensitive adhesive layer disposed on a lower surface of the lower protection layer, a release film disposed on a lower surface of the pressure sensitive adhesive layer, and a surface protection film.

The mutually stacked left spiral cholesteric phase liquid crystal film and right spiral cholesteric phase liquid crystal film are disposed between the surface protection film and the upper protection layer.

The present application further provides an anti-blue light polarizer including at least a left spiral cholesteric phase liquid crystal film and at least a right spiral cholesteric phase liquid crystal film. The left spiral cholesteric phase liquid crystal film and the right spiral cholesteric phase liquid crystal film mutually stack, and pitches of the left spiral cholesteric phase liquid crystal in the left spiral cholesteric phase liquid crystal film and pitches of right spiral cholesteric phase liquid crystal in the right spiral cholesteric phase liquid crystal film are within the wavelength range of the blue light.

The pitches of the left spiral cholesteric phase liquid crystal and the pitches of the right spiral cholesteric phase liquid crystal are in 380˜480 nm.

The anti-blue light polarizer further includes a polarizing layer, an upper protection layer and a lower protection layer respectively disposed on upper and lower surfaces of the polarizing layer, a pressure sensitive adhesive layer disposed on a lower surface of the lower protection layer, a release film disposed on a lower surface of the pressure sensitive adhesive layer, and a surface protection film.

The mutually stacked left spiral cholesteric phase liquid crystal film and right spiral cholesteric phase liquid crystal film are disposed between the surface protection film and the upper protection layer.

A material of the polarizing layer is polyvinyl alcohol, and materials of the upper protection layer and the lower protection layer are triacetate cellulose.

Advantages of the present application: the present application provides an anti-blue light polarizer, by disposing the mutually stacked left spiral cholesteric phase liquid crystal film and right spiral cholesteric phase liquid crystal film, and pitches of the left spiral cholesteric phase liquid crystal and pitches of the right spiral cholesteric phase liquid crystal are within the wavelength range of the blue light, the anti-blue light polarizer allows the left spiral cholesteric phase liquid crystal film reflect left spiral light in the blue light and the right spiral cholesteric phase liquid crystal film reflect right spiral light in the blue light, so that all the blue light are reflected and cannot enter human eyes, and then the favorable anti-blue light effect is achieved. The present application provides a liquid crystal display panel, which includes a lower polarizer being a common polarizer and an upper polarizer being an anti-blue light polarizer including the mutually stacked left spiral cholesteric phase liquid crystal film and right spiral cholesteric phase liquid crystal film, and thus the panel does not require an additional anti-blue light film to achieve the favorable anti-blue light effect with premise of not reducing screen brightness and not producing color difference.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 schematically illustrates the structure of current cholesteric phase liquid crystal;

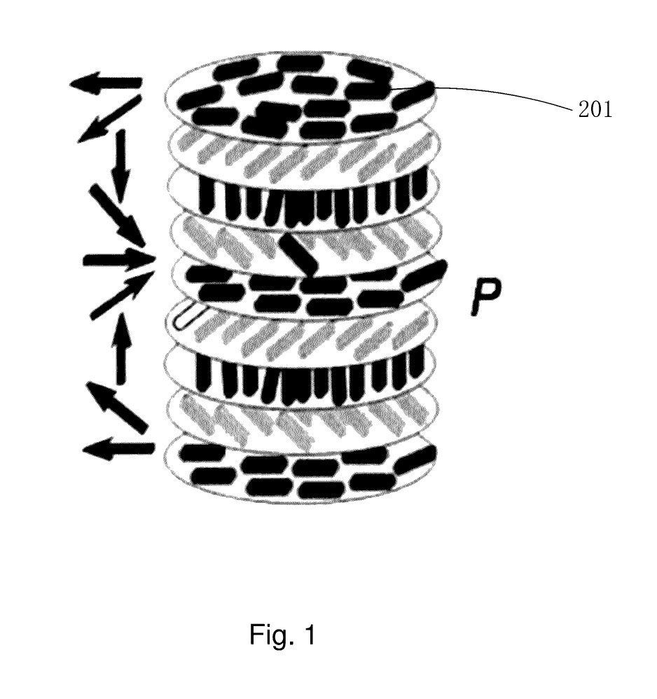

FIG. 2 schematically illustrates the principle of current cholesteric phase liquid crystal having circular dichrome;

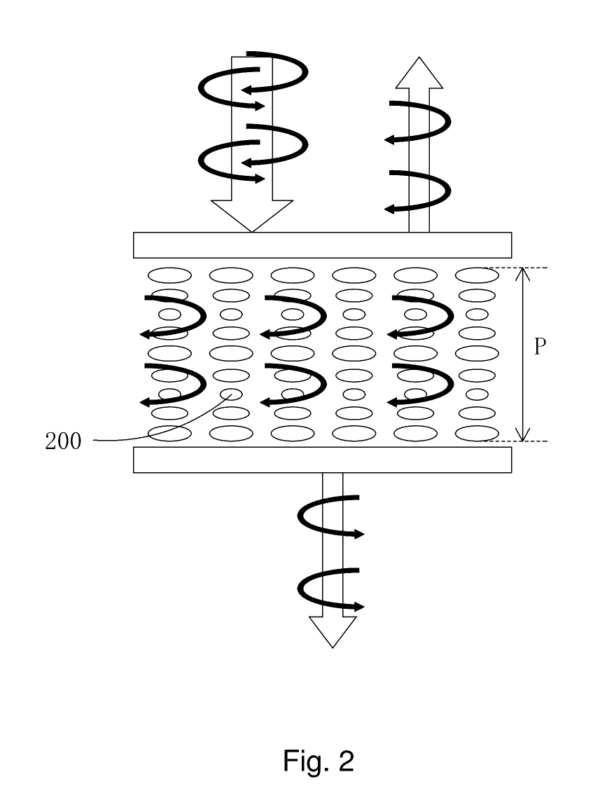

FIG. 3 is a structural block diagram of the anti-blue light polarizer of the present application;

FIG. 4 schematically illustrates working state of the left spiral cholesteric phase liquid crystal film and the right spiral cholesteric phase liquid crystal film in the anti-blue light polarizer of the present application; and

FIG. 5 schematically illustrates the structure of the LCD display panel of the present application.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

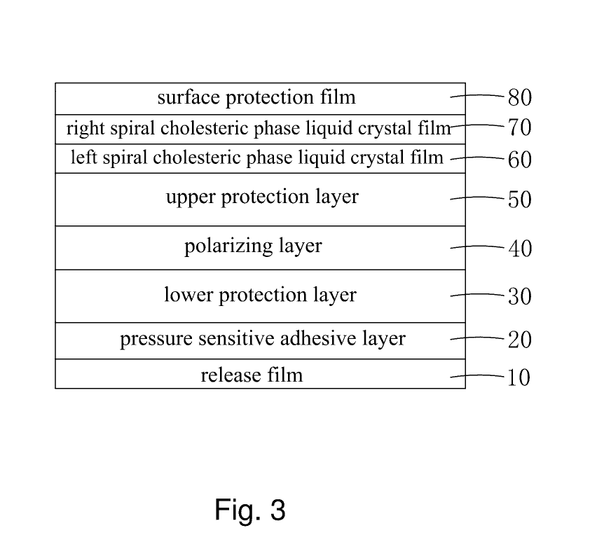

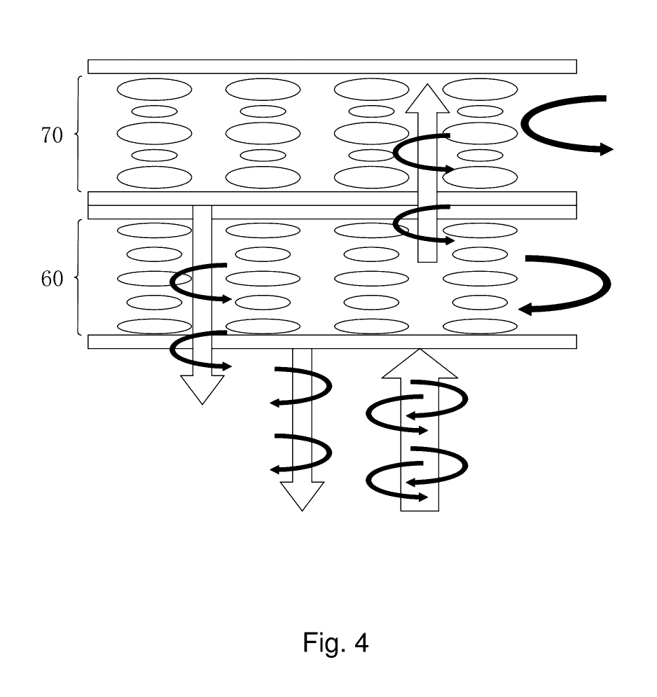

Please also refer to FIG. 3 and FIG. 4, the present application provides a polarizer including a polarizing layer 40, an upper protection layer 50 and a lower protection layer 30 respectively disposed upper and lower surfaces of the polarizing layer 40, a pressure sensitive adhesive layer 20 disposed on a lower surface of the lower protection layer 30, a release film 10 disposed on a lower surface of the pressure sensitive adhesive layer 20, a surface protection film 80, and at least a left spiral cholesteric phase liquid crystal film 60 and at least a right spiral cholesteric phase liquid crystal film 70 disposed between the surface protection film 80 and the upper protection layer 50. The said left spiral cholesteric phase liquid crystal film is that spiral directions of cholesteric phase liquid crystal in the liquid crystal film are left spiral, and the said right spiral cholesteric phase liquid crystal film is that spiral directions of the cholesteric phase liquid crystal in the liquid crystal film are right spiral.

The left spiral cholesteric phase liquid crystal film 60 and the right spiral cholesteric phase liquid crystal film 70 mutually stack, and pitches of the left spiral cholesteric phase liquid crystal in the left spiral cholesteric phase liquid crystal film 60 and pitches of the right spiral cholesteric phase liquid crystal in the right spiral cholesteric phase liquid crystal film 70 are within the wavelength range of the blue light.

Specifically, the pitches of the left spiral cholesteric phase liquid crystal and the pitches of the right spiral cholesteric phase liquid crystal are in 380˜480 nm. To achieve different pitches thereof has two methods, one method includes: adding chiral agents and polymerizable monomers with different properties in the cholesteric phase liquid crystal to allow the cholesteric phase liquid crystal have different pitch profile, then irradiating the cholesteric phase liquid crystal by ultraviolent (UV) to take out a polymerization of the polymerizable monomers, so as to fix the pitches of cholesteric phase liquid crystal; the other method includes: adding polymerizable monomers and UV absorber in the cholesteric phase liquid crystal to form UV intensity gradient in the system by utilizing the characteristic of UV absorber absorbing UV, inducing the polymerizable monomers to form spiral gradient in the system in which has large pitches of cholesteric phase liquid crystal in a side near UV irradiation that causes high polymer network content and less chiral agents, and small pitches of the cholesteric phase liquid crystal in the opposite side that the polymer network content is low and the chiral agents are much after polymerization.

A material of the polarizing layer 40 is polyvinyl alcohol (PVA); materials of the upper protection layer 50 and the lower protection layer 30 are triacetate cellulose (TAC).

The right spiral cholesteric phase liquid crystal film 70 can stack on the left spiral cholesteric phase liquid crystal film 60 in a manner as shown in FIG. 3 and FIG. 4. Certainly, the left spiral cholesteric phase liquid crystal film 60 can stack on the right spiral cholesteric phase liquid crystal film 70.

For example, as shown in FIG. 4, one layer of the right spiral cholesteric phase liquid crystal film 70 stacks on one layer of the left spiral cholesteric phase liquid crystal film 60, due to apparent circular dichrome of the cholesteric phase liquid crystal, when a bundle of the blue light is incident, the left spiral cholesteric phase liquid crystal film 60 firstly reflects left spiral light in the bundle of the blue light, the rest right spiral light in the blue light enter the right spiral cholesteric phase liquid crystal film 70 stacking on the left spiral cholesteric phase liquid crystal film 60, the right spiral cholesteric phase liquid crystal film 70 then reflects the rest right spiral light in the blue light, so that all the blue light are reflected, thus the blue light cannot pass through the stacked left spiral cholesteric phase liquid crystal film 60 and right spiral cholesteric phase liquid crystal film 70 to enter human eyes, and the favorable anti-blue light effect is achieved.

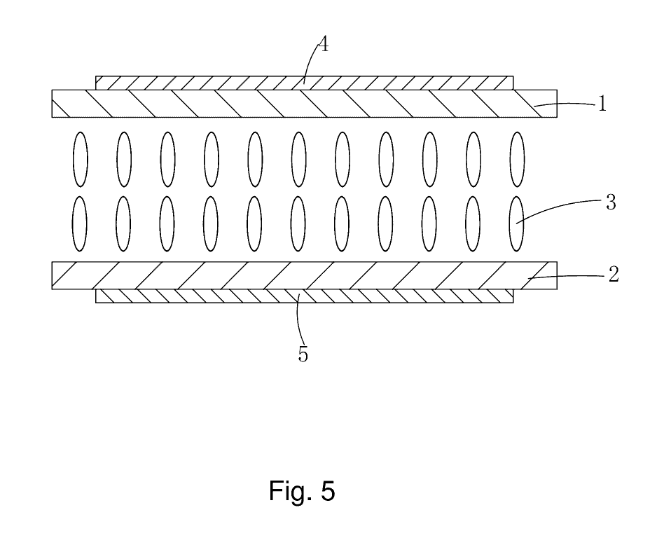

Please refer to FIG. 5, on the basis of the anti-blue light polarizer, the present application further provides a liquid crystal display panel including a color film substrate 1 and an array substrate 2 opposite disposed, a liquid crystal layer 3 disposed between the two substrates, an upper polarizer 4 adhered to a side of the color film substrate 1 away from the liquid crystal layer 3, and a lower polarizer 5 adhered to a side of the array substrate 2 away from the liquid crystal layer 3.

The lower polarizer 5 is a common polarizer, and the upper polarizer 4 is the aforesaid anti-blue light polarizer as shown in FIG. 3 and FIG. 4. The description of structure and working process of the anti-blue light polarizer will not be repeated herein.

Due the lower polarizer 5 is a common polarizer, and the upper polarizer 4 is an anti-blue light polarizer including the mutually stacked left spiral cholesteric phase liquid crystal film 60 and right spiral cholesteric phase liquid crystal film 70, the liquid crystal display panel of the present application does not need an additional anti-blue light film, so that the favorable anti-blue light effect can be achieved with the premise of not reducing screen brightness and not producing color difference.

Based on the above description, in the anti-blue light polarizer of the present application, by disposing the mutually stacked left spiral cholesteric phase liquid crystal film and right spiral cholesteric phase liquid crystal film, and the pitches of the left spiral cholesteric phase liquid crystal and the pitches of the right spiral cholesteric phase liquid crystal are within the wavelength range of the blue light, so that the left spiral cholesteric phase liquid crystal film reflects the left spiral light in the blue light, and the right spiral cholesteric phase liquid crystal film reflects the right spiral light in the blue light, all the blue light are thus reflected and cannot enter human eyes, and the favorable anti-blue light effect is achieved. The present application provides a liquid crystal display panel, a lower polarizer thereof is a common polarizer, an upper polarizer thereof is an anti-blue light polarizer including the mutually stacked left spiral cholesteric phase liquid crystal film and right spiral cholesteric phase liquid crystal film, the liquid crystal display panel does not need an additional anti-blue light film, the favorable anti-blue light effect can be achieved with the premise of not reducing screen brightness and not producing color difference.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An anti-blue light polarizer, comprising:
at least a left spiral cholesteric phase liquid crystal film and at least a right spiral cholesteric phase liquid crystal film; wherein the left spiral cholesteric phase liquid crystal film and the right spiral cholesteric phase liquid crystal film mutually stack, and pitches of the left spiral cholesteric phase liquid crystal in the left spiral cholesteric phase liquid crystal film and pitches of the right spiral cholesteric phase liquid crystal in the right spiral cholesteric phase liquid crystal film are within wavelength range of the blue light.

2. The anti-blue light polarizer according to claim 1, wherein the pitches of the left spiral cholesteric phase liquid crystal and the pitches of the right spiral cholesteric phase liquid crystal are in 380˜480 nm.

3. The anti-blue light polarizer according to claim 1, wherein the right spiral cholesteric phase liquid crystal film stacks on the left spiral cholesteric phase liquid crystal film.

4. The anti-blue light polarizer according to claim 1, wherein the left spiral cholesteric phase liquid crystal film stacks on the right spiral cholesteric phase liquid crystal film.

5. The anti-blue light polarizer according to claim 1, further comprising:
a polarizing layer, an upper protection layer and a lower protection layer respectively disposed on upper and lower surfaces of the polarizing layer, a pressure sensitive adhesive layer disposed on a lower surface of the lower protection layer, a release film disposed on a lower surface of the pressure sensitive adhesive layer, and a surface protection film;
wherein the mutually stacked left spiral cholesteric phase liquid crystal film and right spiral cholesteric phase liquid crystal film are disposed between the surface protection film and the upper protection layer.

6. The anti-blue light polarizer according to claim 5, wherein a material of the polarizing layer is polyvinyl alcohol; and materials of the upper protection layer and the lower protection layer are triacetate cellulose.

7. A liquid crystal display panel, comprising:
a color film substrate and an array substrate opposite disposed, and a liquid crystal layer disposed between the color film substrate and the array substrate, an upper polarizer adhered to a side of the color film substrate away from the liquid crystal layer, and a lower polarizer adhered to a side of the array substrate away from the liquid crystal layer;
wherein the upper polarizer is an anti-blue light polarizer including at least a left spiral cholesteric phase liquid crystal film and at least a right spiral cholesteric phase liquid crystal film; the left spiral cholesteric phase liquid crystal film and the right spiral cholesteric phase liquid crystal film mutually stack, and pitches of the left spiral cholesteric phase liquid crystal in the left spiral cholesteric phase liquid crystal film and pitches of the right spiral cholesteric phase liquid crystal in the right spiral cholesteric phase liquid crystal film are within wavelength range of the blue light.

8. The liquid crystal display panel according to claim 7, wherein the pitches of the left spiral cholesteric phase liquid crystal and the pitches of the right spiral cholesteric phase liquid crystal are in 380˜480 nm.

9. The liquid crystal display panel according to claim 7, wherein the right spiral cholesteric phase liquid crystal film stacks on the left spiral cholesteric phase liquid crystal film, or the right spiral cholesteric phase liquid crystal film stacks on the left spiral cholesteric phase liquid crystal film.

10. The liquid crystal display panel according to claim 9, wherein the anti-blue light polarizer further comprises a polarizing layer, an upper protection layer and a lower protection layer respectively disposed on upper and lower surfaces of the polarizing layer, a pressure sensitive adhesive layer disposed on a lower surface of the lower protection layer, a release film disposed on a lower surface of the pressure sensitive adhesive layer, and a surface protection film;
wherein the mutually stacked left spiral cholesteric phase liquid crystal film and right spiral cholesteric phase liquid crystal film are disposed between the surface protection film and the upper protection layer.

11. An anti-blue light polarizer, comprising:
at least a left spiral cholesteric phase liquid crystal film and at least a right spiral cholesteric phase liquid crystal film; wherein the left spiral cholesteric phase liquid crystal film and the right spiral cholesteric phase liquid crystal film mutually stack, and pitches of the left spiral cholesteric phase liquid crystal in the left spiral cholesteric phase liquid crystal film and pitches of the right spiral cholesteric phase liquid crystal in the right spiral cholesteric phase liquid crystal film are within wavelength range of the blue light;
wherein the pitches of left spiral cholesteric phase liquid crystal and the pitches of the right spiral cholesteric phase liquid crystal are in 380˜480 nm;
the anti-blue light polarizer further comprises a polarizing layer, an upper protection layer and a lower protection layer respectively disposed on upper and lower surfaces of the polarizing layer, a pressure sensitive adhesive layer disposed on a lower surface of the lower protection layer, a release film disposed on a lower surface of the pressure sensitive adhesive layer, and a surface protection film;
the mutually stacked left spiral cholesteric phase liquid crystal film and right spiral cholesteric phase liquid crystal film are disposed between the surface protection film and the upper protection layer;
a material of the polarizing layer is polyvinyl alcohol; and materials of the upper protection layer and the lower protection layer are triacetate cellulose.

12. The anti-blue light polarizer according to claim 11, wherein the right spiral cholesteric phase liquid crystal film stacks on the left spiral cholesteric phase liquid crystal film.

13. The anti-blue light polarizer according to claim 11, wherein the left spiral cholesteric phase liquid crystal film stacks on the right spiral cholesteric phase liquid crystal film.
